(19) United States
(12) Patent Application Publication
(10) Pub. No.: US 2014/0279021 A1
(43) Pub. Date: Sep. 18, 2014

(54) Ad Manager for a Vehicle Multimedia System

(71) Applicant: FORD GLOBAL TECHNOLOGIES, LLC, Dearborn, MI (US)

(72) Inventors: Perry Robinson MacNeille, Lathrup Village, MI (US); Oleg Yurievitch Gusikhin, West Bloomfield, MI (US); Yimin Liu, Ann Arbor, MI (US); David Allen Kowalski, Toledo, OH (US); Gary Steven Strumolo, Canton, MI (US)

(73) Assignee: FORD GLOBAL TECHNOLOGIES, LLC, Dearborn, MI (US)

(21) Appl. No.: 13/803,215

(22) Filed: Mar. 14, 2013

(51) Int. Cl. G06Q 30/02

(52) U.S. Cl. CPC G06Q 30/0266
USPC 705/14.63

(57) ABSTRACT

A vehicle computer system comprising a receiver configured to wirelessly receive an advertisement, the advertisement including two or more ad components for output to a user, the receiver further configured to communicate the advertisement to a processor. The processor is configured to receive contextual data representative of a vehicle's environment from one or more data sources, output the advertisement and a first set of ad components to the user based on the contextual data, the first set of ad components including a request to interact with the user, receive an input from a user corresponding to the first set of ad components, and output a second set of ad components based on the input received from the user.

### TECHNICAL FIELD

The illustrative embodiments generally relate to advertisement management utilizing a vehicle computer system.

### BACKGROUND

United States Publication No. 2010/0023393 generally relates to a method for automatically creating personalized ads to target a specific individual. The method includes first identifying a potential customer who may be interested in a particular product. An automated process then learns about and understands the customer based on his location and how that person interacts with the particular medium on which the ad is going to be presented. Once the information about the customer is developed, an advertisement is created that includes a collection of ad components that identify parts of the ad that may be of interest to the customer based on the learned information. The ad components are selected from a database of available components. The advertisement is then scheduled and placed in the medium and its measure of effectiveness is determined based on the customer's reaction thereto. These measures of effectiveness are used to further refine parameters in understanding the customer and designing the ad.

United States Publication No. 2004/0193425 generally relates to devices, apparatuses, systems, methods and the like for marketing, promoting and/or advertising a business or product. It also combines applications such as screen savers, desktop assistants and instruction with voice verification technology in a readily installable and operable computer form. The voice interactive applications include visual imagery to attract a user/customer(s) to activate and interact with the application. Once activated, the application prompts the consumer user for voice input. The voice input, once authenticated, can then be processed to interact with a product character to perform tasks such as connecting the consumer user to a web-site associated with the advertised business via a hyperlink. Interaction with the product character in a variety of voice interactive applications provides the consumer user with ready and easy access to further product information, product purchasing capabilities, business contact information, updates on promotional products, and/or the like to facilitate the marketing, promoting and/or advertising of the business.

### SUMMARY

A first illustrative embodiment discloses a vehicle computer system comprising a receiver configured to wirelessly receive an advertisement, the advertisement including two or more ad components for output to a user, the receiver further configured to communicate the advertisement to a processor. The processor is configured to receive contextual data representative of a vehicle's environment from one or more data sources, output the advertisement and a first set of ad components to the user based on the contextual data, the first set of ad components including a request to interact with the user, receive an input from a user corresponding to the first set of ad components, and output a second set of ad components based on the input received from the user.

A second illustrative embodiment discloses an advertisement server comprising a transceiver configured to receive vehicle contextual data from a vehicle, the contextual data including information related to a vehicle environment. The server also includes a processor configured to select an advertisement including one or more ad components based on the contextual data, wherein the one or more ad components include a request to interact with a user, and transmit the advertisement to the vehicle using a wireless transmitter.

A third illustrative embodiment discloses a method of vehicle advertising comprising receiving an advertisement wirelessly including a plurality of ad components. The method further includes receiving contextual data representative of a vehicle's environment, outputting based on the contextual data the advertisement and a first set of ad components including an input request, receiving a input from a user in response to the input request, and outputting a second set of ad components based on the input.

### BRIEF DESCRIPTION OF THE DRAWINGS

FIG. 1 illustrates an example block topology for a vehicle based computing system for a vehicle.

FIG. 2 illustrates an embodiment of the relationship between the cloud, broadcaster, and vehicle.

FIG. 3A illustrates the relationship of the components in the vehicle and how the vehicle computer system relates to them.

FIG. 3B illustrates an alternate embodiment of the relationship between components in the vehicle and how the vehicle computer system relates to them, without utilizing a vehicle radio with a HD receiver.

FIG. 4 illustrates a flow chart for utilizing a vehicle option or pay-as-you go plan for HD radio without advertisements.

FIG. 5 illustrates a flow chart utilizing a talking advertisement using the spoken dialog system.

FIG. 6 illustrates a flow chart utilizing a talking dynamic advertisement using the spoken dialog system.

FIG. 7 illustrates a flow chart for personalized advertisement delivery.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The invention now will be described more fully hereinafter with reference to the accompanying drawings, in which illustrative embodiments of the invention are shown. This invention, may however, be embodied in many different forms and should not be construed as limited to the embodiments set forth herein. Like numbers refer to elements throughout. As used herein the term “and/or” includes any and all combinations of one or more of the associated listed items.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to select between various inputs. Input to both the microphone and the auxiliary connector is converted from analog to digital by a converter 27 before being passed to the processor. Although not shown, these and other components may be in communication with the VCS over a vehicle multiplex network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, nomadic device, key fob and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

FIG. 2 is an illustrative embodiment of the relationship between the cloud, broadcaster, and vehicle. Vehicles 201 may be equipped with computer systems or mobile devices utilized to communicate with a broadcaster. The broadcaster 213 may utilize a transmission tower 203 to transmit data and signals over the air to distribute broadcasted content. The transmission tower 203 may distribute AM or FM signals, as well as HD Radio content. As HD radio or AM/FM signals are used continuously through the specification, any type of radio signal may be utilized, including satellite radio, internet radio, etc. HD Radio is a trademark for iBiquitiy's in-band on-channel (IBOC) digital radio technology that is used by AM/FM radio stations to transmit audio and data utilizing a digital signal embedded on-frequency within a stations standard analog signal. This allows a user to listen to the same program in either HD (digital w/less noise) or as a standard broadcast (analog radio with poorer sound quality). HD Radio allows for multiple audio streams and other digital data such as text, image, video, and computer programs to be transmitted within each station's allocated bandwidth. A special receiver is typically required to receive the content.

An IBOC encoder/decoder may be utilized in a radio, in a vehicle computer system such as FORD SYNC, or in a cell phone. With IBOC, The local broadcaster may stream audio via the audio channel 205, including music, advertisements, and talk programs for traditional radios without IOC. In addition, a digital data channel 207 may be utilized to send data, such as RDS (Radio Data System) to send time, station identification and program information. The RDS protocol includes additional data that may be streamed via the text channel. Additionally, High Definition (HD) Radio Content may include additional HD music channels, such as an HD2 channel 209 and HD3 channel 211. The HD2 and HD3 channel maybe utilized to stream additional genre or sub-genre content for a broadcaster.

Although the illustrative embodiment discloses a transmission tower 203 broadcasting content to a vehicle with a receiver, the local broadcaster may also stream data via an internet connection utilizing the internet. Thus a user may be capable of utilizing a mobile phone, tablet, etc, to retrieve content from a local broadcaster.

The vehicles 201 may in turn utilize an internet connection 215, or any other long-range connection 215, to communicate to the broadcaster utilizing a server 217. This may allow for indirect two-way communication between the vehicle and a broadcaster by utilizing the back-door path. A connection 215 to the server may be accomplished utilizing the nomadic device, cellular broadband utilized by the vehicle computer system (VCS), or from a Wi-FI network. The server may be utilized by advertisers, merchants, broadcasters and vehicle occupants. The broadcasters, merchants, and advertisers may use the analytics engine 221, analytics database 223, and ad server 219, to store ads, store analytics results from the vehicles, characterize the audience in real-time, and determine the value of a particular ad. The vehicle system may also provide data to the analytics engine to characterize the preferences of individual vehicle occupants, but this may be done automatically without direct control of vehicle occupants.

By utilizing an internet connection 225, the server 217 may be capable of communicating with the local broadcaster 213. This will allow the server 217 to retrieve data from the vehicle and send that data to the broadcaster. Thus, broadcasters have an opportunity to communicate and retrieve analytical data from the vehicle. Furthermore, user profile data including information about the user may be included. Such information may include the make or model of the vehicle, name of the user, demographic information, etc.

FIG. 3A illustrates the relationship of the components in the vehicle and how the vehicle computer system relates to them. The vehicle multimedia system 301 may be equipped with a data storage drive 303 to store files, content, and other data. The vehicle multimedia system may include an IBOC radio receiver 305, which may be required to communicate to the IBOC channel of the AM/FM station. The vehicle multimedia system 301 may communicate 315 text, analog and digital sound, and images to a vehicle radio 317. Additionally, the IBOC receiver 319 (e.g. HD radio) may be located within the vehicle radio 319. Furthermore, the vehicle radio 317 may be equipped with the data storage device 321. Additionally, other signals may be sent from the broadcaster utilizing different wireless transmission means.

The vehicle multimedia system 301 may also be configured to communication with a mobile device 337. The mobile device may utilize an application program interface 335 to allow software 339 on the mobile device. Such mobile applications 339 may include broadcasted content from the internet radio. Furthermore, the mobile device 337 may be equipped with an IBOC receiver 341 to allow the mobile device to receive content utilizing a HD Radio channel. The mobile device 337 will also include data storage 343 to store data and files.

The mobile device may also be used in conjunction with the vehicle multimedia system 301 to communicate with an off-board server 347. This may allow content to delivered 345 to the server. The communication may be two-way between the mobile device and the server 347.

The vehicle multimedia system 301 may also be in communication with various vehicle components utilizing the vehicle's data bus 323, such a CAN. Information may be retrieved from the vehicle components that may be useful for advertisers to acquire. For example, GPS coordinates of its viewers may be retrieved from the vehicle multimedia system communicating with the GPS module on the bus 323.

One of the components that the vehicle multimedia system 301 may communicate with is a workload estimator 325. The workload estimator may be useful in determining the vehicle environment that the driver is in. Furthermore, it may help in calculating the driver's workload or attention demand. Thus, broadcasted content, such as advertisements, may be delivered in a vehicle environment wherein the driver's attention is not in high demand. The workload estimator 325 may be in communication with various vehicle sensors 333 to determine the user's attention demand. Such sensors may include the windshield wipers, brake module, headlamps, navigation system, a mobile cell phone, or an off-board server. A description of the functionality and utilization of the workload estimator may be described in related to U.S. application Ser. No. ______/______, having attorney docket number FMC 4290 PUS, filed Mar. ______, 2013, the disclosure of which is herein incorporated by reference in its entirety.

The vehicle sensors may independently or collectively provide contextual data to the workload estimator to allow the estimator to predict the vehicle environment. Furthermore, the vehicle sensors may also be in communication with an off-board server to retrieve off-board data to utilize with the workload estimator. For example, a Bluetooth transceiver may be in communication with a mobile phone, which in turn may communicate with an off-board server can provide traffic data, weather data, and other off-board data. The vehicle may also utilize its own cellular connection to communicate with the off-board server.

The contextual data utilized may help facilitate the output of the advertisement. For example, the advertisement may be output only when the attention demand value for a driver is below a certain threshold requirement. Thus, the advertisement may be output when the vehicle is not moving. Furthermore, on-board processors may determine an optimal ad component to select based on contextual data, user profile data, or frequency data. Thus, on-board processors may realize that an optimal time to output an advertisement may be during a snow storm or traffic jam.

Sampling and analysis 327, 329, 331 may be utilized for driver distraction, drowsiness detection, handling limit, people sleeping, people conversing, driver confusion, etc. Various vehicle modules may be utilized for the sampling and analysis. A human machine interface (HMI) 307 may be in communication with the vehicle multimedia system 301 to allow the user and content to interact with one another. The content retrieved may contain programming that allows it to respond to user inputs. The HMI may be utilized in a heads up display 309, spoken dialog system 311, or a conventional knob or button 313. All inputs that are utilized for the HMI may be available for dynamic or non-linear advertisements which may request user interaction.

FIG. 3B illustrates an alternative embodiment of the relationship between components in the vehicle and how the vehicle computer system relates to them, without utilizing a vehicle radio with a HD receiver. Instead, the embodiment of FIG. 3B may simply leverage the HD radio receiver of the mobile device to retrieve broadcasts from HD stations.

The mobile device may communicate to the vehicle computer system via a wireless and wired communication. Some examples of the different connections may be Bluetooth, Wi-Fi/Wi-Fi Direct, USB, Firewire, Serial Cable, etc. The vehicle computer system may include an application program interface, such as AppLink™ to leverage the HD application from a mobile device. Each application or station that is broadcasted from the mobile device may be validated by a policy server. The policy server may ensure that the app is entitled to run with the vehicle computer system. Furthermore, the app may request the policy server to check if each station and substation of the mobile app is permitted to be played under the payment plan of the mobile app. Once approved, the app may obtain the vehicle's VIN, the mobile device ID, and a key ID to store with the station ID. The app may play until a new station is selected, APPLINK signals the app to stop, the occupant terminates the app from the mobile device or vehicle, or the occupant leaves the car. A data record may be written with the VIN, key ID, station, and elapsed time. The mobile device may be configured to sync all the records that are transferred to an analysis engine and database in an off-board server. The broadcaster or advertisers billing agents may be able to use the analysis engine to determine from the vehicle, he mobile device ID, the Key ID, and the station ID which account to bill and which account to credit based on the amount of data transferred. Furthermore, the application may be validated for security as well. Once the HD radio mobile app is validated and running, the HD radio may be able to play over the vehicle speakers.

FIG. 4 illustrates a flow chart for utilizing a vehicle option or pay-as-you go plan for HD radio without advertisements. The VCS may receive a request from a mobile phone to utilize the vehicle stereo 401. The VCS may utilize a policy to check the authorization of the application or the mobile device 403. The VCS may determine if the APP is secure 405 utilizing the policy and/or a FORD APPLINK server for authentication. If the app is not secure, the mobile device will be denied any access to the VCS.

If the APP is verified as secured and authorized, the VCS will allow the APP and the mobile device to be utilized with the VCS. The VCS or mobile device may then verify if the application subscription is active 407. The VCS or mobile device may communicate with the APP developer or broadcaster to verify the HD radio subscription. If the subscription does not allow interaction with a VCS, or the subscription is not active, the APP may end.

The VCS may send the VIN, mobile device ID, and key ID to the broadcaster or application developer 409 once the subscription is verified. This may allow the advertiser to be aware of how a user it utilizing the mobile app. The application may continue to stream the broadcast until a number of scenarios are present. In one example, a new station may be requested 411 by the user of the application. Upon selecting a new station, the stream will suspend momentarily until the application receives the content being streamed from the new station.

In another scenario, the user or the vehicle may request the application to stop 413. This will result in the broadcast to end the stream of data. In another scenario, the application may simply just end 415 due to a software bug, battery life, or other similar scenarios. In yet another scenario, the application/mobile device may not retrieve a signal to the broadcaster 417. Thus, if no signal is available, content may not be streamed by the application or the mobile device. Therefore, the broadcast will terminate.

During the broadcast, the mobile device or application may record the pertinent info to the memory of the mobile phone or the vehicle. Upon recording the pertinent data, the data may be sent to the server or broadcaster 421 for utilization. Such data that may be pertinent could include listening behavior of a genre of stations, listening time, contextual data related to the vehicle environment, and analytics data related to the advertisement behavior of any ads utilized by the mobile device or vehicle.

The mobile device or vehicle may send the data automatically, or through manual interaction required by the user. In some embodiments, the user may be required to “push” the data at each instance. In the alternative, the data may be automatically sent to the server or broadcaster via a wireless connection. The VCS may utilize its own transceiver for the internet connection, or utilize the mobile device's connection.

FIG. 5 may utilize a flow chart for a talking Ad using spoken dialog system with FORD SYNC and HD Radio. The HD Radio broadcaster may utilize a chat bot for utilization of advertisements. A chatter robot, or chat bot is a computer program designed to simulate a conversation with one or more users via auditor or textual methods, primarily for engaging in small talk. Typically, the chat bot may utilize natural language processing systems, however, many can simply scan keywords within the input and a pull a reply with the most matching keywords from a text database.

An advertiser may develop a chatbot and enter it into an adserver 501. The advertiser may offer to pay for every vehicle that receives an add and a bonus for any vehicle receiving the ad near a specific shopping mall. Through utilization of the vehicle data that is retrieved from the off-board server, the advertiser may have access to analytics data to understand the value of the advertisement. The advertiser may retrieve demographic data and be allowed to deliver target advertisements to the vehicle environment based on vehicle data. For example, a Starbucks may send an advertisement to the vehicle based on the location of the vehicle, as well as utilizing additional features.

The talking ad may include grammar developed in a language such as Nuance Grammar Language, VoiceXML, AIML, or equivalent. The grammar from the language engine may output what the dialog system says to the occupants, what actions to take on a particular occupant response, how to respond to changes in the sampling and analysis modules, and what response data to collect, and the data collected on recognition errors. The response data may be text and/or binary audio data.

The system may collect rich data that may include occupant state information based on direct recognition of utterances, word choice, speech prosody, etc. The data is used for analytics that determine the value of an ad, data for improving ads and correcting error in the ads. Data may be used to indicate when a user ignores an ad, utilizes an ad, how the user utilizes the ad (i.e. via voice or manual input), demographics of the user receiving the ad, or an optimal time to output an ad.

The ad may also be capable of the selection and use of a voice provided by SYNC rather than a recorded voice. Similarly, music may also be provided in a text format and played at the same time as the voice using Music Instrument Digital Interface (MIDI) or the equivalent and a synthesizer.

The adserver may send the ad to the radio broadcaster 503. Thus, the radio broadcaster can stream the advertisement via HD Radio's IBOC channel. The text channel may be utilized to send the advertisement when other media is currently playing, or concurrently with an HD Radio broadcast. The advertisement may be a visual add or an audible add played through the vehicle speakers.

If the advertisement is received via an HD radio broadcast via the user's phone, the phone may determine if it is currently operable in the vehicle 505. Thus, an advertisement that is not meant for vehicle use may not be pertinent to announce in another environment. Thus, the phone or mobile device may determine if there is a current Bluetooth connection with the vehicle computer system. Additionally, it may check to determine if an active APPLINK connection is established with the vehicle multimedia system. If the mobile device determines that it is currently not in or connected to a vehicle, it may simply ignore the advertisement 509.

If the mobile device determines that it is in a vehicle environment, it may save the received advertisement for the next advertisement break 509. Thus, the advertisement may not interrupt current music that is being broadcasted. Upon determining that the advertisement break is running, the vehicle may determine if a high workload situation arises. The vehicle computer system may analyze context data to calculate an attention demand value. If the attention demand value meets a certain criteria, the VCS may determine it is not preferable to output the advertisement. The VCS may send a message to the server indicating the workload value 511. In another embodiment, the VCS may retrieve the advertisement, but delay the output of the advertisement based on the workload value. When workload is high, the VCS may send a message to server indicating that the workload is currently high and to delay the advertisement. Thus, the advertisement may be played when the workload value is lowered and there is an advertisement break. On the other hand, if the workload is low, the VCS may send a message to the server indicating it is okay to send the advertisement to the vehicle. Thus the server will send the advertisement to the vehicle at the advertisement break and when the workload value is low 513. Additionally, an embodiment without identifying the workload value or the advertisement break may be utilized as well.

Upon retrieving the advertisement from the server, the VCS may load the advertisement for output to the user. The advertisement may leverage the VCS's text-to-speech engine, or may be of another audio format. The advertisement may require the user to provide feedback for certain commands. For example, an advertisement for McDonalds may talk about a special on an extra value meal, and then ask the user “Would you like to visit the nearest McDonald's?” The user may respond in various manners, such as via electromechanical inputs such as a steering wheel switch, touch screen, faceplate button, or via a verbal command. Thus the user may say “Yes” or “No”, to which the voice recognition engine of the multimedia system or server may process.

Additionally, the advertisement may request the user press a special button to provide input. Additionally, special button presses may be utilized, such as a long hold for a certain amount of time, a double press or triple press, or any combination thereof. For example, the advertisement may state “If you would like to visit McDonald's, press the volume up button on your steering wheel control or stereo, otherwise you can press the push to talk switch to cancel, or simply wait for the advertisement to end.

Upon the VCS receiving the input commands from the user, the VCS may send the occupant feedback to the server. The server may receive the feedback 515 via the connection and utilize the feedback to determine a next step action item.

Additionally, contextual information from the sampling and analysis modules may be collected, including GPS locations. The VCS may load the data into a mobile device, which in turn may send the data to an analytics database. The analytics database may determine that a follow-up to a customer is necessary, such as sending an e-mail, coupon, sale, reservation, pledge, etc. Also, the customer may have an option to skip the ad after a few seconds if the product is uninteresting or the ad is unpleasant. The customer may be able to input a reason for skipping the ad so that in the future, the ad server and broadcaster can determine more appropriate advertisements to send to the user.

Additionally, a mobile device or a VCS that is used in the transaction relating to the ad may also record information representative of the mobile device or VCS into the analytics database.

Additionally, the server may receive contextual information from the VCS or mobile device 517. The contextual information may be indicative of different driving behaviors associated with a user. The contextual information may include data from vehicle module (e.g. wiper usage, fuel usage, headlamp usage, braking module data, engine control data, etc), or data collected from an off-board server, such as traffic data or weather data. Thus, an advertiser or broadcaster may understand the effectiveness of an advertisement based on the contextual information. For example, advertisement may not be effective during a traffic jam or a thunderstorm as compared to a sunny, dry driving environment. Thus, advertisers and broadcasters are capable of determining effective context for advertisement delivery and output a custom advertisement to the user based on the various data retrieved from the vehicle.

Furthermore, the server may receive analytics data 519 from the VCS, mobile phone, or even the advertiser or broadcaster. The analytics data can be used to create association tables, or other learned structures containing abstractions of the data. The association tables may link driver actions with context variables. In one illustrative example, the data may indicate a request for a follow-up, a coupon, request to take a survey after a purchase, or to skip the ad before it is complete for a specific reason. Context parameters may include a VIN number, a MyKey ID, a phone number, windshield wiper level, time of day, date of year, ambient temperature, workload estimate, product, ad type, number of times the ad has been played, etc. An association rule may include a statistical analysis, such as “out of 100 samples (statistical strength) 90% of the time (statistical significance with 50% being low an 0% and 100% being high) the a vehicle with the VIN number “N” at the time of day noon responded to an advertisement for food by survey over WiFi at a particular restaurant.

The association rules can be created automatically using various algorithms, and while the HD Radio advertisement may be only partially individualized, the data collected can be used for fully individualized applications. In one example, a political ad may be played for a particular candidate on a particular issue. The driver responds by turning down the volume and driving behavior indicates the driver is not paying attention. The analytics system would develop an association rule that would prevent the ad server from using this issue for this candidate either through the HD Radio or other marketing approaches. Further, if many drivers have similar responses in a particular class of vehicle (from the VIN) the analytics can develop a rule not to deliver ads for this candidate on this issue to vehicles of a certain class.

After receiving the analytics data, the contextual information, and the occupant feedback, the server may send the data to the advertiser or broadcaster. The data may be sent individually or bundled together. Furthermore, the data may be sent to additional parties. Upon receiving the data, the advertiser and the merchant may review the data to improve future advertisements.

FIG. 6 illustrates a flow chart utilizing a talking dynamic advertisement using the spoken dialog system. The server or broadcaster may receive an advertisement with segments and components 601. Traditionally, advertisements may be a single stream, but in a dynamic or non-linear implementation, three or more audio segments are spliced together in real-time under the control of a script. In an embodiment which utilizes three segments, one segment may always play first, and one of the remaining two segments may be sliced onto the end of the first, while the other is discarded. The choice of which segment to use and which to discard may depend on the output of one of the sampling and analysis modules, or based on a spoken response into the dialog system. Typically, as a segment ends there is an instruction such as a press button or beep the horn (political advertising), and the non-linear ad implementation would choose the next segment based on this action by the occupants.

Prior to loading the advertisement, the vehicle may determine if the workload value is high for the user 603. If the workload value is high, it may simply wait to load the advertisement until the workload value is at an appropriate amount. Otherwise, the vehicle computer system (VCS) may proceed to continue actions to load the advertisement.

The VCS may then determine if a commercial break 605 exists to load the advertisement. If the VCS does not receive indication from the broadcaster or server that commercial break exists, it may wait until the commercial break in order to not interrupt any streamed content to the user. Additionally, the VCS may receive data to evaluate when to create a commercial break within a vehicle environment.

Upon determining a commercial break exists, the VCS or server may output the advertisement with the segments or components 607. Thus the advertisement may have multiple paths dependent on the input of the vehicle occupant. For example, the advertisement may ask a user if they are in need of gas. If a user states that they are, it may offer five different locations of a specific brand or multiple brands of gas stations. Dependent on the selection of gas station that the user chooses, different directions or output may be provided to the user.

The VCS or server may determine if an input is received 609. Different inputs may load different advertisement segments or components based on the input. If no input is received from the user, then the advertisement may time out after a certain amount of seconds. The VCS may record all data, including ignored data to provide feedback to the advertiser. Thus, an advertiser may recognize that certain advertisements are not efficient and try another approach to reach to their target audience.

Verbal commands touch screen control, steering wheel controls, and hard buttons may all be methods of receiving input from the driver. The VCS may receive the input and store the input in memory. Additionally, the VCS may send the input to the server, who may then send the input to the broadcaster. The new segments or components may already have been received when the VCS initially received the advertisement, or may receive new ad components once different inputs are retrieved from a user 611.

Verbal commands touch screen control, steering wheel controls, and hard buttons may all be methods of receiving input from the driver. The VCS may receive the input and store the input in memory. Additionally, the VCS may send the input to the server, who may then send the input to the broadcaster. The new components may already have been received when the VCS initially received the advertisement, or may receive new ad components once different inputs are retrieved from a user 613. Additionally, the ad script may select one of the alternative components and load it based on the occupant's actions or from results of an analysis module.

During the dynamic advertisement being loaded, the VCS may collect all contextual data that is utilized during the advertisement. Thus, the advertiser or broadcaster may later analyze the contextual data, along with other analytics data, to determine when an advertisement is most effective. For example, long term contextual and analytics data may show that a user is more or less likely to be receptive to an advertisement during a traffic jam or a weather storm. Thus, an advertiser may understand when it is best to output an advertisement. GPS location information may also be utilized to provide location data or probe data to the advertisers or broadcasters.

Upon collecting all relevant contextual, analytics data, and any other input related to the advertisement, the VCS may send the data to the server. The VCS may be able to leverage a nomadic device or its own internet connection to send the data to a server. Additionally, a user's mobile device may be able to load the data into an analytics database. If the mobile device is utilized for the transaction relating to the ad, the transaction may also be recorded in the analytics database.

The server may be able to distribute the data in any manner necessary, i.e. to a broadcaster, advertiser, merchant, marketing agency, etc. A broadcaster and/or advertiser may use the analytics engine to review results from the mobile devices for every vehicle that received the ad. The advertiser may then be able to pay the broadcaster for each advertisement received, rather for just general airplay. Furthermore, an advertiser may be able to pay a broadcaster additional revenue based on contextual information, actions the occupant may have requested, and/or transaction involving the cell phone. After reviewing the data and notifying trends, the advertiser and merchant may review the analytics data to improve future dynamic advertisements. For example, an apparel retailer might offer a low price for advertising a rain coat anytime over the air. The retailer may offer additional revenue to the broadcaster if the advertisement is delivered within a geofence around the mall where the retailer is located. Additionally, additional revenue may be offered to the broadcaster if the ad is played when the windshield wipers are on. If the ad is played more than 5 times but less than 10 times within the geofence, and also when the wipers are on, the advertiser might offer an additional bonus to the broadcaster. Thus an illustrative embodiment could provide a way to deliver two or more ads to each vehicle, one to be played if conditions for an additional bonus were in effect and the other to be played if an additional bonus was not in effect. The server may store all related data indicative of the bonuses to optimize broadcasting of the advertisement.

FIG. 7 illustrates a flow chart for personalized advertisement delivery. An advertiser may create an advertisement and tag the advertisement with an attribute vector that describes the target listener and context for the advertisement. Additionally, the ad server may be capable of tagging an advertisement with an attribute vector. Bonuses maybe available to reward listeners who received the advertisement with the characteristics specified in the attribute vectors. The ad may be received from the broadcaster via the advertisement server into the vehicle or to a user's mobile device. Furthermore, a VCS or a mobile device used in conjunction with the VCS, may receive the advertisement with the attribute vector 701. The vehicle computer system may collect occupant identifying information contextual information from the sample and analysis modules and store it in memory of the VCS, or on a mobile device. The mobile device or VCS may connect to the analytics engine and create a preference attribute vector. The preference attribute vector may be based on analytics data about the occupants, other data in the cloud, and context information from the sample and analytics module. Thus, the analytics engine may create a real-time profile of the vehicle listener base for the broadcaster. The engine may provide data to the broadcaster or utilize the data to automatically build association rules or similar learned decision support methods geared towards the user.

An analytics engine may evaluate the advertisement 703 and tag the ad with an attribute vector with advertisement characteristics, such as but not limited to length, age rating, music type, product, etc. The attribute vectors may be included in the advertisement and/or the ad components. The attribute vectors may be utilized along with a user profile of a vehicle's user to determine a target audience to play the advertisement.

Furthermore, the attribute vectors may work with contextual data or a workload estimator. For example, the attribute vectors may be utilized to trigger a specific add during a certain vehicle environment, such as a traffic jam or when the wipers are turned as. In one example, the server may tag the ad with an attribute vector that triggers the ad upon wipers being turned on. Thus, the ad may be for a windshield wiper manufacturer. Upon tagging the ad with the attribute vectors and sending off the advertisement to the broadcaster, the advertiser may utilize the ad. Or in an alternate embodiment, the advertisement may output when a low fuel warning is present.

The server may then proceed to select an advertisement based on the listener 705 utilizing the user profile. The user profile may give insight to the history of feedback from the user or information about the user, such as age, sex, demographic information, phone manufacturer used with the vehicle, music preference, Point of Interest (POI) preference, etc. Thus, the ad server may select ads that are made for a specific audience. For example, an advertisement may be selected for offering concert tickets for an up and coming heavy metal band. The ad server would likely select the ad for younger demographics, rather than older demographics. The ad server may receive data from the advertiser indicating the type of target audience to broadcast.

The server may send the ad to the broadcaster 707, along with other related data representative of the listener. Further, the server may transmit the advertisement to the vehicle, either directly or through a broadcaster. Thus, the vehicle may communicate to the broadcaster indirectly via the server because the server may receive profile data and contextual data related to the user. In turn, the server may be able to send the data to the broadcaster or advertiser. Thus, the broadcaster or advertiser may utilize the data to determine effectiveness of an advertisement or to analyze the data to determine a target audience.

The server may receive the contextual information or data 709 upon retrieval of the advertisement. The contextual information may include data indicating what, when, and how the user interacted with the advertisement. Additionally, the contextual data may include information related to when an advertisement is not successfully received or utilized by a listener.

The server may then create/update a profile 711 for the user. The profile may be updated based on the feedback from the user. For example, if the server recognizes that the user no longer responds to certain types of ads (i.e. for fast food restaurants), it may update the profile of the user to tailor selection of different advertisements. Furthermore, it can also update any changes to the user profile that may impact selection of the advertisement. For example, if the server receives data that the manufacturer of the paired Bluetooth phone has changed from one manufacture to another, it may update the profile to indicate that change. Thus, it may tailor advertisements to send information specifically to that manufacturer, such as APPLE. Therefore, when selecting an advertisement, the ads may select APPLE accessory advertisements rather than SAMSUNG accessory advertisements.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle computer system comprising:
a receiver configured to wirelessly receive an advertisement, the advertisement including two or more ad components for output to a user, the receiver further configured to communicate the advertisement to a processor, the processor configured to:
receive contextual data representative of a vehicle's environment from one or more data sources;
output the advertisement and a first set of ad components to the user based on the contextual data, the first set of ad components including a request to interact with the user;
receive an input from a user corresponding to the first set of ad components; and
output a second set of ad components based on the input received from the user.

2. The vehicle computer system of claim 1, wherein the processor is further configured to send contextual data to a server via a transceiver.

3. The vehicle computer system of claim 2, wherein the transceiver is a wireless communication module connected to a mobile device.

4. The vehicle computer system of claim 2, wherein the contextual data is representative of the vehicle environment near a time the advertisement is output.

5. The vehicle computer system of claim 2, wherein the transceiver is further configured to send a user profile including information related to the user to a server, and receive the advertisement including one or more ad components based on the user profile.

6. The vehicle computer system of claim 1, wherein the input from a user corresponding to the one or more ad components is verbal.

7. The vehicle computer system of claim 1, wherein the input from a user corresponding to the one or more ad components is an electromechanical input.

8. The vehicle computer system of claim 1, wherein the advertisement including the one or more ad components includes sound, text, image, or video.

9. The vehicle computer system of claim 1, wherein the receiver is configured to receive the advertisement via an in-band on-channel broadcast.

10. The vehicle computer system of claim 1, wherein processor is further configured to output the advertisement and the first set of ad components to the user at a time determined based upon a workload value.

11. The vehicle computer system of claim 1, wherein processor is further configured to output the advertisement and the first set of ad components to the user based upon a user profile that includes information about the user.

12. The vehicle computer system of claim 11, wherein the user profile includes data indicating demographics information related to the user.

13. An advertisement server comprising:
a transceiver configured to receive vehicle contextual data from a vehicle, the contextual data including information related to a vehicle environment; and
a processor configured to:
select an advertisement including one or more ad components based on the contextual data, wherein the one or more ad components include a request to interact with a user; and
transmit the advertisement to the vehicle using a wireless transmitter.

14. The advertisement server of claim 13, wherein the advertisement is transmitted to the vehicle using a broadcaster.

15. The advertisement server of claim 13, wherein the processor is further configured to select the advertisement including one or more ad components based on an analytics engine configured to determine a user's preference.

16. The advertisement server of claim 13, wherein the transceiver is further configured to receive user profile data from the vehicle, the user profile data including information related to demographic information of the user.

17. The advertisement server of claim 13, wherein the advertisement further includes one or more attributes related to a characteristic associated with the advertisement, wherein the attributes are configured to facilitate output of the advertisement during a driving scenario correlated to the attributes.

18. A method of vehicle advertising, comprising:
receiving an advertisement wirelessly including a plurality of ad components;
receiving contextual data representative of a vehicle's environment;
outputting based on the contextual data the advertisement and a first set of ad components including an input request;
receiving a input from a user in response to the input request; and
outputting a second set of ad components based on the input.

19. The method of claim 18, the method further including the step of sending contextual data to a server.

20. The method of claim 19, the sending of contextual data to a server is via a wireless communication module connected to a mobile device.
